(19) United States
(12) Patent Application Publication
(10) Pub. No.: US 2019/0164540 A1
(43) Pub. Date: May 30, 2019

(54) VOICE RECOGNITION SYSTEM AND VOICE RECOGNITION METHOD FOR ANALYZING COMMAND HAVING MULTIPLE INTENTS

(71) Applicants: Hyundai Motor Company, Seoul (KR); Kia Motors Corporation, Seoul (KR)

(72) Inventor: Sung Soo Park, Seoul (KR)

(21) Appl. No.: 15/980,326

(22) Filed: May 15, 2018

(30) Foreign Application Priority Data
Nov. 28, 2017 (KR) 10-2017-0160367

(51) Int. Cl. G10L 15/18; G10L 15/22; G06F 17/27

(52) U.S. Cl. CPC G10L 15/1815; G10L 15/22; G10L 2015/223; G06F 17/2755; G10L 15/1822; G06F 17/278

(57) ABSTRACT

A voice recognition system for analyzing an uttered command having multiple intents can include: a controller configured to receive the uttered command, extract a plurality of intent data sets from the uttered command, determine a second intent data set from a first intent data set among the extracted plurality of intent data sets, and generate a feedback message based on the second intent data set and the first intent data set; a storage configured to store the uttered command and the extracted plurality of intent data sets; and an output device configured to output the feedback message.

### CROSS-REFERENCE TO RELATED APPLICATION

This application is based on and claims the benefit of priority to Korean Patent Application No. 10-2017-0160367, filed on Nov. 28, 2017 in the Korean Intellectual Property Office, the disclosure of which is incorporated herein in its entirety by reference.

### TECHNICAL FIELD

The present disclosure relates to a voice recognition system and a voice recognition method for analyzing a command having multiple intents, and more particularly to a voice recognition system and a voice recognition method for analyzing a command having multiple intents, in which meanings of a voice command having multiple intents are connected with each other to execute the command based on the intent of an utterer.

### BACKGROUND

As use of mobile devices, such as smartphones, has expanded, the interest in voice recognition has increased. Generally, voice recognition techniques involve automatically identifying a linguistic meaning from a voice. Specifically, these techniques may involve a processing procedure of identifying a word or a word string by inputting a voice waveform and of extracting the meaning of the word or the word string.

The voice recognition is generally classified into five types: speech analysis, phoneme recognition, word recognition, sentence analysis, and semantic extraction. In a narrower sense, voice recognition may refer to a procedure from voice analysis to word recognition.

The objective of the voice recognition is to implement full speech-to-text conversion by automatically recognizing voice resulting from natural vocalization as a command to be executed or to input the voice into a document. Accordingly, speech understanding systems have been developed to extract an exact meaning of continuous speech or sentences using syntax information, semantic information, and information or knowledge related to given tasks, as well as the simple recognition of a word. Research and development of such a system is actively performed all over the world.

Meanwhile, a typical speech processing method processes a recognized voice by predicting utterance intent and recognizing an entity name. The prediction of the utterance intent is to determine the intent of an utterer based on the utterance of the utterer. Typically, the prediction of the utterance is performed through utterance intent prediction classification. The recognition of the entity name allows for finding an entity, which serves as a factor in determining the utterance intent. For example, the recognition of the entity name is predicted through multiple-label classification.

However, if the utterance intent is predicted through utterance intent prediction classification, multiple utterance intents included in one utterance case may not be predicted. If the multiple-label classification is used, the reliability of predicting the utterance intent may be diminished.

### SUMMARY

The present disclosure has been made to solve the above-mentioned problems occurring in the related art while advantages achieved by the prior art are maintained intact.

An aspect of the present disclosure provides a voice recognition system and a voice recognition method for analyzing a command spoken by an utterer having multiple intents to recognize the multiple intents of the utterer.

The technical problems to be solved by the present disclosure are not limited to the aforementioned problems, and any other technical problems not mentioned herein will be clearly understood from the following description by those skilled in the art to which the present disclosure pertains.

According to embodiments of the present disclosure, a voice recognition system for analyzing an uttered command having multiple intents can include: a controller configured to receive the uttered command, extract a plurality of intent data sets from the uttered command, determine a second intent data set from a first intent data set among the extracted plurality of intent data sets, and generate a feedback message based on the second intent data set and the first intent data set; a storage configured to store the uttered command and the extracted plurality of intent data sets; and an output device configured to output the feedback message.

In addition, the controller can determine content of a first entity among a plurality of entities included in the first intent data set, and determine, from the content of the first entity, content of a second entity, which is the same as the first entity, among a plurality of entities included in the second intent data set.

In addition, the controller can detect whether a linker is present in the uttered command, and determine that the uttered command has multiple intents when the linker is detected in the uttered command.

Further, the controller can divide the uttered command into a plurality of intent-based sentences, and determine the multiple intents based on the divided plurality of intent-based sentences.

In addition, the controller can extract the plurality of intent data sets based on the multiple intents determined from the plurality of intent-based sentences.

In addition, the controller can divide the uttered command into the plurality of intent-based sentences through morphological and parsing analyses.

Further, the controller can associate the first intent data set with the second intent data set.

In addition, the controller can determine the second intent data set based on external content information when the second intent data set fails to be determined from the first intent data set.

In addition, the controller can detect a meaning of the uttered command through a text analysis.

Further, when a link is detected to be absent from the uttered command, the controller can extract an intent data set based on an intent of the utterer, and additionally extract a new intent data set based on a meaning of the uttered command.

In addition, the controller can extract a plurality of intent data sets including an intent data set for text sending when a portion of contents of the uttered command includes content for the text sending, and determine content of a specific entity included in the intent data set for the text sending from content of a specific entity included in an intent data set extracted based on contents of the uttered command except for the content for the text sending.

In addition, the controller can generate an action data set, which includes one or more results corresponding to the uttered command, based on the plurality of intent data sets.

Further, the controller can generate the feedback message based on the action data set.

In addition, the output device can output the feedback message in a form of a voice or an image.

Furthermore, according to embodiments of the present disclosure, a voice recognition method for analyzing an uttered command having multiple intents can include: receiving the uttered command; extracting a plurality of intent data sets from the command; determining a second intent data set from a first intent data set among the extracted plurality of intent data sets; generating a feedback message based on the first intent data set and the second intent data set; and outputting the feedback message using an output device.

In addition, the extracting of the plurality of intent data sets can include determining whether the uttered command has multiple intents.

In addition, the determining of whether the uttered command has multiple intents can include detecting whether a linker is present in the uttered command; and determining that the uttered command has multiple intents when the linker is detected in the uttered command.

In addition, the extracting of the plurality of intent data sets can further include dividing the uttered command into a plurality of intent-based sentences; and determining the multiple intents based on the divided plurality of intent-based sentences.

Further, the dividing of the uttered command can include dividing the uttered command into the plurality of intent-based sentences through morphological and parsing analyses.

In addition, the extracting of the plurality of intent data sets can further include extracting the plurality of intent data sets according to the multiple intents from the plurality of intent-based sentences.

In addition, the first intent data set and the second intent data set can each include multiple entities.

In addition, the voice recognition method can further include determining whether the plurality of intent data sets are associated with each other after the extracting of the plurality of intent data sets.

Further, the determining of whether the multiple intent data sets are associated with each other can include determining the first intent data set as associated with the second intent data set when a common entity is extracted from both of the first intent data set and the second intent data set.

Besides, the voice recognition method can further include determining the second intent data set from the first intent data set after the determining of whether the plurality of intent data sets are associated with each other.

In addition, the determining of the second intent data set from the first intent data set can include determining, from content of a first entity which is included in the first intent data set, content of a second entity which is included in the second intent data set, the second entity being the same as the first entity.

In addition, the voice recognition method can further include determining the second intent data set based on external content information when the second intent data set fails to be determined from the first intent data set.

Further, the voice recognition method can further include additionally extracting a new intent data set based on a meaning of the uttered command, after the extracting of the plurality of intent data sets, when a linker is detected to be absent from the uttered command.

In addition, the voice recognition method can further include extracting a plurality of intent data sets including an intent data set for text sending when a portion of content of the uttered command includes content for the text sending; and determining information of a specific entity included in the intent data set for the text sending from an intent data set extracted according to contents of the uttered command except for the content for the text sending.

Further, the voice recognition method can further include generating an action data set, which includes one or more results corresponding to the uttered command, after the determining of the second intent data set from the first intent data set.

In addition, the generating of the feedback message can include generating the feedback message based on the action data set.

In addition, the outputting of the feedback message can include outputting the feedback message in a form of a voice or an image.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view illustrating a smart agent including a vehicle terminal system included inside a vehicle and a voice recognition system according to the present disclosure;

FIG. 2 is a block diagram illustrating a voice recognition system for analyzing a command having multiple intents

FIG. 3 is a view illustrating the clustering of similar intents in a voice recognition system according to the present disclosure;

FIG. 4 is a view illustrating entities extracted according to intents;

FIG. 5 is a view illustrating an extracted common entity included in intent data sets, according to embodiments of the present disclosure;

FIG. 6 is a view illustrating the mapping of information in each intent dataset, according to embodiments of the present disclosure;

FIG. 7 is a view illustrating the inference of information in each intent data set, according to embodiments of the present disclosure;

FIG. 8 is a flowchart illustrating a voice recognition method for analyzing a command having multiple intents according to the present disclosure;

FIG. 9 is a schematic view illustrating the voice recognition method, according to embodiments of the present disclosure;

FIG. 10 is another schematic view illustrating a voice recognition method, according to embodiments of the present disclosure; and

FIG. 11 is a block diagram illustrating a computing system to execute the method, according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. In the following description, the same reference numerals will be assigned to the same elements even though the elements are illustrated in different drawings. In addition, in the following description, a detailed description of well-known features or functions will be ruled out in order not to unnecessarily obscure the gist of the present disclosure.

In the following description of elements according to an embodiment of the present disclosure, the terms ‘first’, ‘second’, ‘A’, ‘B’, ‘(a)’, and ‘(b)’ may be used. The terms are used only to distinguish relevant elements from other elements, and the nature, the order, or the sequence of the relevant elements is not limited to the terms. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the team “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. The controller may control operation of units, modules, parts, or the like, as described herein. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

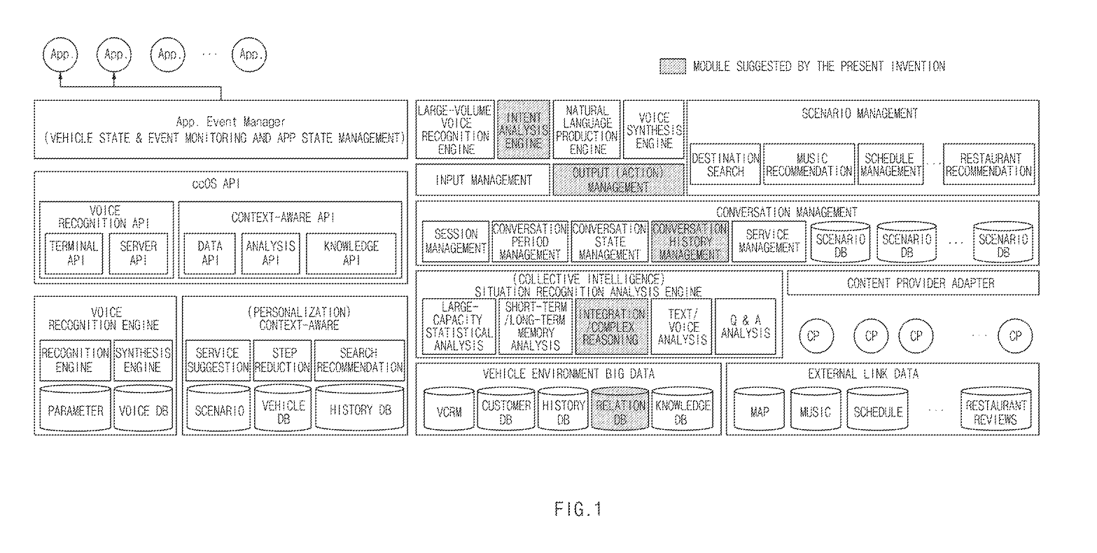

FIG. 1 is a schematic view illustrating a smart agent including a vehicle terminal system included in a vehicle and a voice recognition system according to the present disclosure.

As illustrated in FIG. 1, a vehicle may include a vehicle terminal system and a smart agent.

The vehicle terminal system is classified into an application (“App”) event manager, an application programming interface (API), a context-aware engine, and a voice recognition engine according to functions.

The App event manager may monitor a vehicle state and an event occurring in an application and may manage and control an application state. The API may include an API for interworking a voice recognition engine of the terminal with a voice recognition engine of a server and an API for interworking the context-aware engine with the smart agent. The context-aware engine may recommend or suggest a service based on context data and may process operation steps by applying a context analysis result to result data. In addition, re-sorting may be performed by applying a situation analysis result to search information. Since the voice recognition engine has the same parts as those of the smart agent, the details of the voice recognition engine will be understood by making reference to the following description of the smart agent.

The smart engine may be classified into input management, output management, scenario management, conversation management, a context-aware analysis engine, and big data for a vehicle environment according to functions.

The input management may include a voice recognition engine and an intent analysis engine. The voice recognition system according to the present disclosure may include functions performed by the intent analysis engine.

The voice recognition engine may convert a voice to a text, may recognize voices for isolated words inside the vehicle terminal system, and may recognize a large-volume voice inside the smart agent. The intent analysis engine may extract an intent data set using a natural language processing technique of a text which is the result of voice recognition processing. In addition, the intent analysis engine may extract an entity, which is main information associated with the intent classification of the text and the relevant intent.

The output management may be expressed as action management and may include a natural language production engine and a voice synthesis engine. The voice recognition system according to the present disclosure may include a function performed in the output management.

The natural language production engine may analyze actions expected in the future and may produce a text to be output. In addition, parameters related to the voice synthesis engine may be produced by analyzing the produced text. The voice synthesis engine may convert the text produced by the natural language production engine into a voice. The voice synthesis engine may output a fixed voice by synthesizing the fixed voice inside the vehicle terminal system and may output a parameter-based emotion and personalization voice inside the smart engine.

The scenario management is to manage scenarios (e.g., destination search, music recommendation, schedule management, etc.) for vehicle service, and may be linked to an external content (e.g., map, music, schedule, or the like) other than the vehicle together with a content provider adapter.

The conversation management may include session management, conversation addition management, conversation state management, conversation history management, and service management, and the voice recognition system according to the present disclosure may include functions performed in conversation history management.

The session management is to manage continuity for each conversation topic (intent data set), and the additional conversation management is performed by adding or deleting conversation topics (intent data sets). The conversation state management may manage the state between conversation topics (intent data sets). In addition, the conversation history management may identify and reconfigure the association between conversation topics (intent data sets), and the service management may manage services associated with the conversation topic (intent data set), or may manage a scenario database, a scenario state, and CP interworking.

The context aware analysis engine can include functions of large-scale statistical analysis, short-term/long-term memory analysis, complex reasoning, text/voice analysis, and query response analysis. The voice recognition system according to the present disclosure may include functions performed in the complex reasoning.

The large-scale statistical analysis includes the analysis of a use pattern based on the use history. The short-term/long-term memory analysis may include analysis to restore associated information based on the use history. The complex reasoning may be performed through mapping between mutually different pieces of information. The text/voice analysis is to infer a situation by analyzing voice information and text information. The query response analysis is to infer a response by analyzing a query content of a user.

Big data under a vehicle environment may include vehicle customer relation management (VCRM), customer data, historical data, relationship data, and knowledge base.

The VCRM may include vehicle usage information data, the customer data may include subscription customer information data, the history data may include information data on the service usage history, association data may include the association between data, data on link information, and the knowledge base may include knowledge information data required for a query and a response.

According to the present disclosure, the command having multiple intents of an utterer may be analyzed using some functions illustrated in FIG. 1.

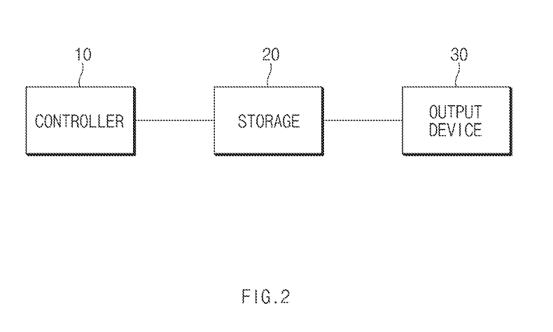

FIG. 2 is a block diagram illustrating a voice recognition system for analyzing a command having multiple intents, according to the present disclosure.

As illustrated in FIG. 2, the voice recognition system for analyzing the command having the multiple intents according to the present disclosure may include a controller 10, a storage 20, and an output device 30.

The controller 10 may analyze the command having the multiple intents.

The controller 10 determines whether multiple intents are present in a command uttered by an utterer. The command uttered by the utterer may include a natural language having a sentence. According to embodiments of the present disclosure, the uttered command may include a linker such as “and”, “while”, and “in addition”. If the linker is included in the uttered command, the controller 10 may determine the command to have the multiple intents.

If the uttered command has the multiple intents, the controller 10 may divide sentences according to intents. To this end, learning may be performed such that sentences having similar meanings are clustered and a command having multiple intents may be additionally learned.

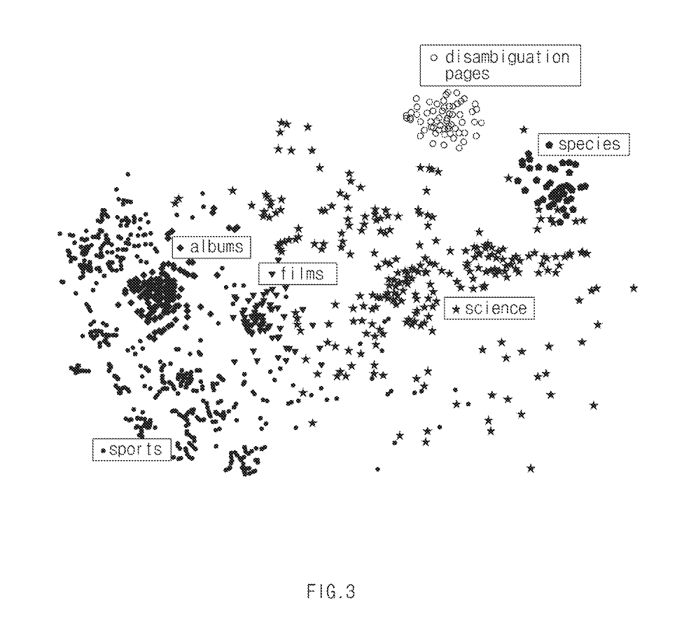

According to embodiments of the present disclosure, the controller 10 first converts an uttered command into texts to perform learning such that the sentences having the similar meanings are clustered. In addition, the converted texts are transformed into a vector in hundreds of dimensions and substituted into a real number space. The commands having the similar meanings in the real number space may be clustered in the same color as illustrated in FIG. 3. Commands having the same meaning may be present in the space clustered in the same color. According to the present disclosure, the controller 10 may additionally learn a command having multiple intents among the commands having the same meaning.

In addition, the controller 10 may perform morphological and parsing analyses with respect to vague sentence regions due to the overlap between sentences. For example, if a linking word or phrase (“linker”) such as “when”, “and”, or “in addition” is included in a voice uttered by an utterer, the controller 10 may divide sentences. For example, if the command is “When you get to the destination, let me know the weather there”, the controller 10 may determine “When” as the linker” to divide the command into two sentences of “you get to the destination” and “let me know the weather there”. Hereinafter, the sentence of “you get to the destination” is referred to as “first sentence” and the sentence of “let me know the weather there” is referred to as “second sentence” for the convenience of explanation.

The controller 10 may analyze the intents of the utterer in the divided sentences. For example, the intent of the utterer for the first sentence may be analyzed as that the utterer wants to know the information on the destination. In addition, the intent of the utterer for the second sentence may be analyzed as that the utterer wants to know the information on weather from the second sentence.

The controller 10 may extract an intent data set based on the analyzed intents of the utterer. The intent data set may refer to data, which includes information used to execute the uttered command, based on the analyzed intent of the utterer. The intent data set may include a plurality of entities obtained by classifying information, which is used to execute the uttered command, according to items. The entities may include the name of point of interest (POI), a region, the type of a business, a street, taken time, weather, a name, a call category, a phone number, a date, a time, a message, or the like.

For example, the controller 10 may extract a first intent data set shown below in Table 1 based on the intent of the utterer for the first sentence. The first intent data set may include five entities and may have the following information on the five entities. Content of each entity included in the first intent data set may be acquired using information on the first sentence. Since the information on the first sentence is related to “destination”, the content of each entity may be acquired using information of a navigation system provided inside a vehicle.

TABLE 1

| Entity | Content |
|---|---|
| Name Of POI | AA Center |
| Region | Hwaseong, Gyeonggi-Do. |
| Type Of Business | Shopping Mall |
| Distance | 30 Km |
| Taken Time | 58 Min. |

For example, the controller 10 may extract a second intent data set shown below in Table 2 based on the intent of the utterer in the second sentence. The second intent data set may include three entities and may have the following information on the three entities. Content of each entity included in the second intent data set may be acquired using information on the second sentence. However, since the second sentence is related to “weather there”, contents on “Time” and “Weather” may not be acquired except for the entity related to the region.

TABLE 2

| Entity | Content |
|---|---|
| Region | There |
| Time | ? |
| Weather | ? |

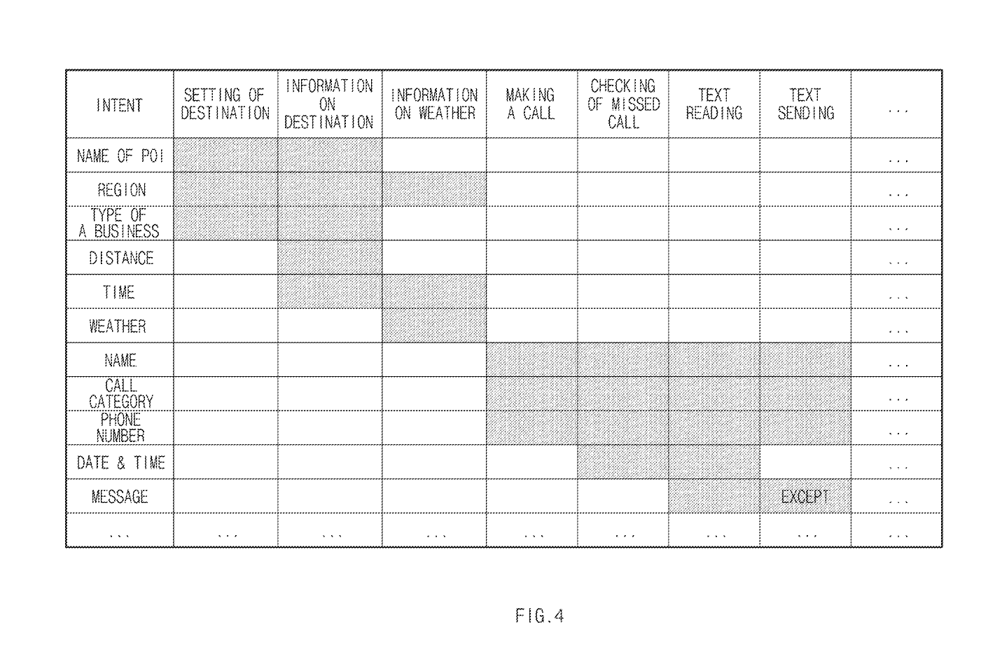

FIG. 4 is a view illustrating entities extracted according to intents.

As illustrated in FIG. 4, a specific entity may be extracted from mutually different intents in common. For example, “region” may be an entity extracted in the case that the intent of the utterer is related to one of “the setting of a destination”, “information on the destination”, and “information on weather”.

In the case that the specific entity is extracted from mutually different intents in common, the mutually different intents may be associated with each other. Accordingly, content of a specific entity acquired from one intent data set may correspond to content of a specific entity acquired from a different intent data set. In FIG. 4, items arranged in a lengthwise direction represent entities and items arranged in a widthwise direction may the intent of a user.

For example, “region” among the entities may be a common entity between entities corresponding to “the setting of a destination”, “information on the destination”, and “the information on weather” which are the intents of the user. Accordingly, content of “region” extracted from entities for “the setting of the destination” may be mapped to content of “region” extracted from entities for “the information on the destination” and “the information on the weather”.

Accordingly, contents of the entities of “the name of POI”, “region”, “type of a business”, “time”, “name”, “call category”, “phone number”, and “date & time” among the entities illustrated in FIG. 4 may be mapped into the mutually different intents of a user including relevant entities.

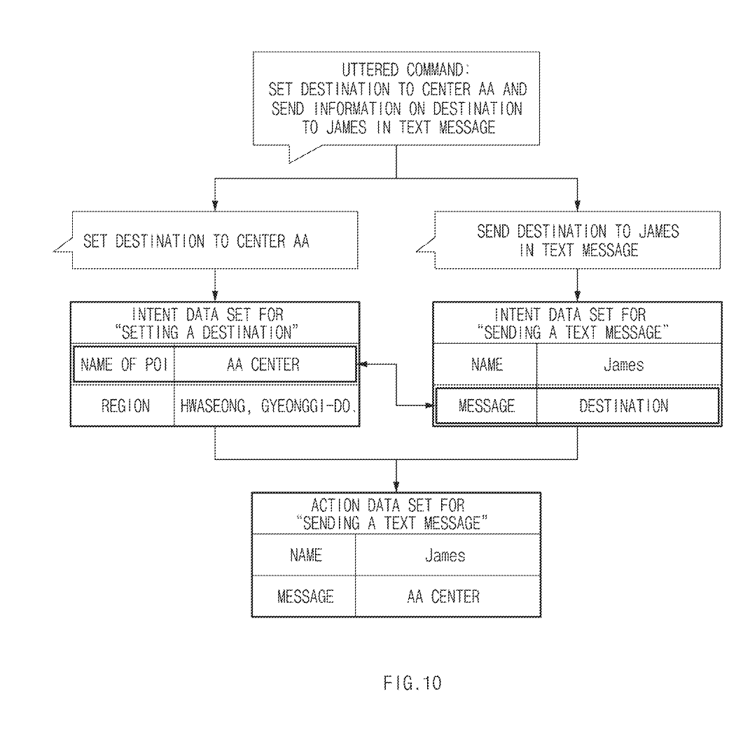

Meanwhile, in the case that the intent of “sending a text message” is included in the intents of an utterer, the information on “message” among entities extracted corresponding to “text sending” is commonly applied together with the information on “message” among entities extracted corresponding to “text reading”. The detailed description of “text sending” may be made with reference to FIG. 10.

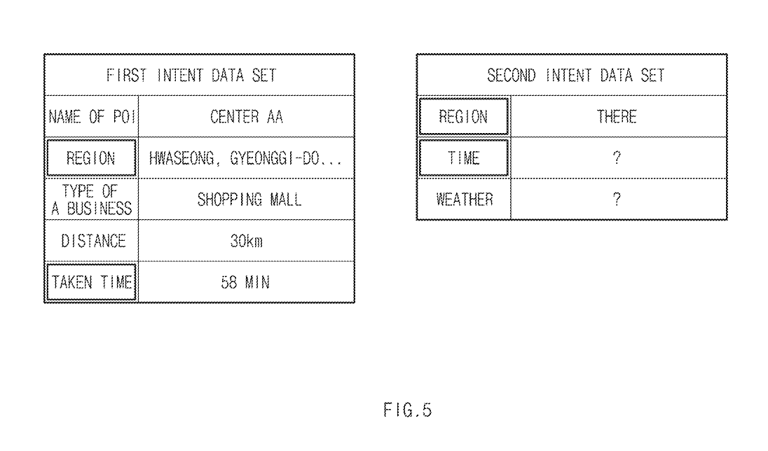

The controller 10 may extract a common entity among entities extracted corresponding to intents to detect the association between mutually different intents using information of FIG. 4. The details thereof will be described with reference to FIG. 5.

FIG. 5 illustrates extracted common in intent data sets according to embodiments of the present disclosure. As illustrated in FIG. 5, common entities extracted from the first sentence and the second sentence may be “region” and “time”. Accordingly, the controller 10 may detect that the first sentence and the second sentence have the association therebetween in terms of “region” and “time”. Accordingly, the intent data sets of FIG. 5 may be detected as intent data sets associated with each other.

In addition, if the controller 10 determines the intent data sets to be associated with each other, the controller 10 may infer information included in any one of the associated intent data sets from information included in another of the associated intent data sets.

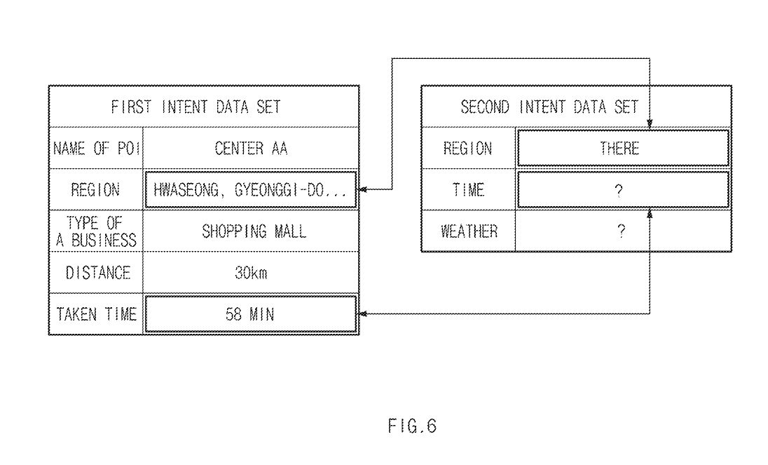

To this end, content of a specific entity acquired from any one intent data set may be mapped to content of a specific entity acquired from another intent data set. The details thereof will be described with reference to FIG. 6.

FIG. 6 is a view illustrating the mapping of information in each intent data set, according to embodiments of the present disclosure. The controller 10 may map the content of the entity of “region” of the first intent data set to the content of the entity of “region” of the second intent data set as illustrated in FIG. 6. In addition, the controller 10 may map the content of the entity of “taken time” of the first intent data set to the content of the entity of “time” of the second intent data set.

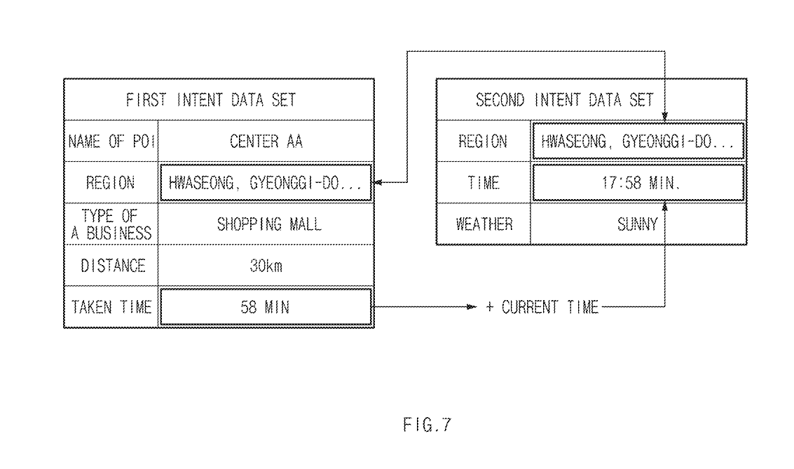

The controller 10 may infer contents of entities, which are not acquired from the second intent data set, from contents of entities of the first intent data set mapped to the contents of the entities of the second intent data set. The details thereof will be described with reference to FIG. 7.

FIG. 7 is a view illustrating the mapping of information in each intent data set, according to embodiments of the present disclosure.

The controller 10 may analyze a text to detect an exact meaning of a recognized word, if it is difficult to detect the exact meaning of the recognized word by using only the recognized word. The controller 10 may not detect an exact meaning of “there” in the second sentence by using only “there”. Accordingly, the controller 10 may recognize that the word of “there” is a pronoun referring to “place” through the text analysis. In this case, the controller 10 may make an inference that the content of the entity of “region” extracted from the first intent data set corresponds to “there” as illustrated in FIG. 7.

In addition, as illustrated in FIG. 7, the controller 10 may infer content of “time” among entities extracted from the second intent data set by adding current time to the information of “taken time” among entities extracted from the first intent data set. According to embodiments of the present disclosure, referring to Table 1, if the entity of “taken time” among the entities extracted from the first intent data set is 58 minutes and the current time is “17:00”, the controller 10 may infer, as “17:58”, “time” among entities extracted from the second intent data set.

In addition, the controller 10 acquires the content of the relevant entity in the second intent data set based on the inferred content. Contents of entities that the controller 10 fails to infer may be acquired from external contents. The external contents may include music, a map, a schedule, weather, a search service, or the like. Accordingly, the second intent data set may acquire the result shown below in Table 3.

TABLE 3

| Entity | Contents |
|---|---|
| Region | Hwaseong, Gyeonggi-do. |
| Time | 17:58 |
| Weather | Sunny |

In addition, the controller 10 may create an action data set. The action data set may be created based on result information of the uttered command. In other words, the action data set may be created such that the action data set includes only information desired by the utterer based on the intent of the utterer. According to embodiments of the present disclosure, an action data set may be created based on Table 3 as shown below in Table 4.

TABLE 4

| Entity | Content |
|---|---|
| Arrival time | 17:58 |
| Weather | Sunny |

In addition, the controller 10 may determine a feedback message from the created action data set. According to embodiments of the present disclosure, the feedback message may be determined to be a message of “the arrival time at the destination is 17:58 and the weather of the destination is sunny at that time”.

Referring back to FIG. 2, the storage 20 may store the uttered command, and multiple intent data sets and an action data set extracted by the controller 10.

The output device 30 may determine the feedback message based on the created action data set. According to an embodiment, the output device 30 may output the feedback message in the form of a voice or an image.

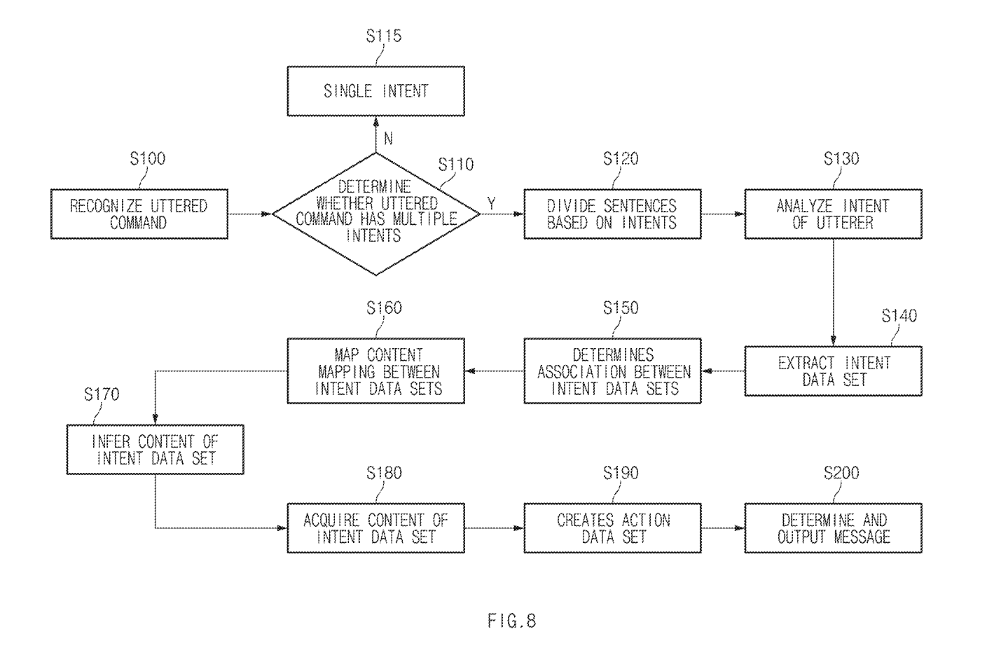

FIG. 8 is a flowchart illustrating a voice recognition method for analyzing a command having multiple intents according to the present disclosure.

As illustrated in FIG. 8, the controller 10 recognizes a command uttered by an utterer (S100).

The controller 10 determines whether the uttered command has multiple intents (S110). In operation S110, if a linker, such as “and”, “while”, and “in addition”, is included in the command uttered by the utterer, the controller 10 may determine the uttered command to have the multiple intents. If the command is determined to have the multiple intents (Y), the controller 10 may perform operation S120. If the command is not determined to have the multiple intents (N), the controller 10 may determine the command to have a single intent (S115).

After operation S115, the controller 10 may perform operation S130 to analyze the intent of the utterer and may extract an intent data set by performing operation S140. In this case, if the content of the entity included in the single intent data set is insufficient, the controller 10 may additionally create an intent data set allowing the acquisition of contents of entities.

If the command is determined to have the multiple intents, the controller 10 may divide the command of the utterer into intent-based sentences (S120). Operation 120 may include performing a learning operation such that sentences having the similar meanings are clustered and a learning operation for the command having multiple intents. In operation 120, if a linker is detected in the command, the command may be divided into the intent-based sentences. The linker may include “when”, “and”, or “in addition”. According to embodiments of the present disclosure, if the uttered command is “When you get to the destination, let me know the weather there”, the controller 10 may divide the uttered command into the first sentence of “you get to the destination” and the second sentence of “let me know the weather there”, in operation 120.

If the uttered command is divided into the intent-based sentences, the controller 10 may analyze the intents of the utterer in the divided sentences (S130). In operation S130, the controller 10 may analyze the first sentence as that the utterer wants to know the information on the destination. In addition, the controller 10 may analyze the second sentence as that the utterer wants to know the information on the weather there.

If the intents of the utterer are analyzed, the controller extracts intent data sets according to the intents of the utterer (S140). According to embodiments of the present disclosure, in operation S140, the controller 10 may extract a first intent data set based on the intent of the utterer for the first sentence and a second intent data set based on the intent of the utterer for the second sentence as shown above in Tables 1 and 2. The first and second intent data sets may include data associated with the analyzed intents of the utterer, may include data containing information for executing the uttered command, and may include multiple entities. The details thereof will be understood by making reference to the descriptions of Tables 1 and 2.

The controller 10 determines the association between the extracted first and second intent data sets (S150). In operation S150, if common entities are present between entities extracted from the first intent data set and entities extracted from the second intent data set, the controller 10 may determine the first intent data set to be associated with the second intent data set.

If the first intent data set is determined to be associated with the second intent data set based on the common entities, the controller 10 may infer content to be included in the second intent data set from content included in the first intent data set. To this end, the controller 10 maps contents of the common entities between the first and second intent data sets to each other (S160). In operation 160, according to embodiments of the present disclosure, the content of a first entity extracted from the first intent data set is mapped to content of a first entity extracted from the second intent data set.

After the mapping of the content of the entities, the controller 10 infers the content of the second intent data set (S170). In operation S170, the controller 10 may infer contents of entities, which are not acquired from the second intent data set, from contents of entities of the first intent data set mapped to contents of the entities of the second intent data set. If the second intent data set fails to be inferred from the first intent data set, the controller 10 may infer content of the second intent data set from external content.

The controller 10 acquires the content of the second intent data set based on the inferred content of the second intent data set (S180). The controller 10 may acquire contents, which are not inferred in operation S170, based on external content information. Accordingly, the controller 10 may acquire all contents of the second intent data set.

If the contents of the second intent data set are acquired, the controller 10 creates an action data set (S190). In operation S190, the controller 10 creates the action data set including result information of the uttered command, based on content of a command first issued by the utterer. In other words, the controller 10 may create the action data set such that the action data set includes result information that the utterer wants to know, based on the intents of the utterer. The details thereof will be understood by making reference to table 4.

If the action data set is created, the controller 10 determines and outputs the feedback message (S200). In operation S200, the controller 10 may determine a feedback message of “the arrival time at the destination is 17:58 and the weather of the destination is sunny at that time”. In addition, the feedback message may be output in the form of a voice or an image.

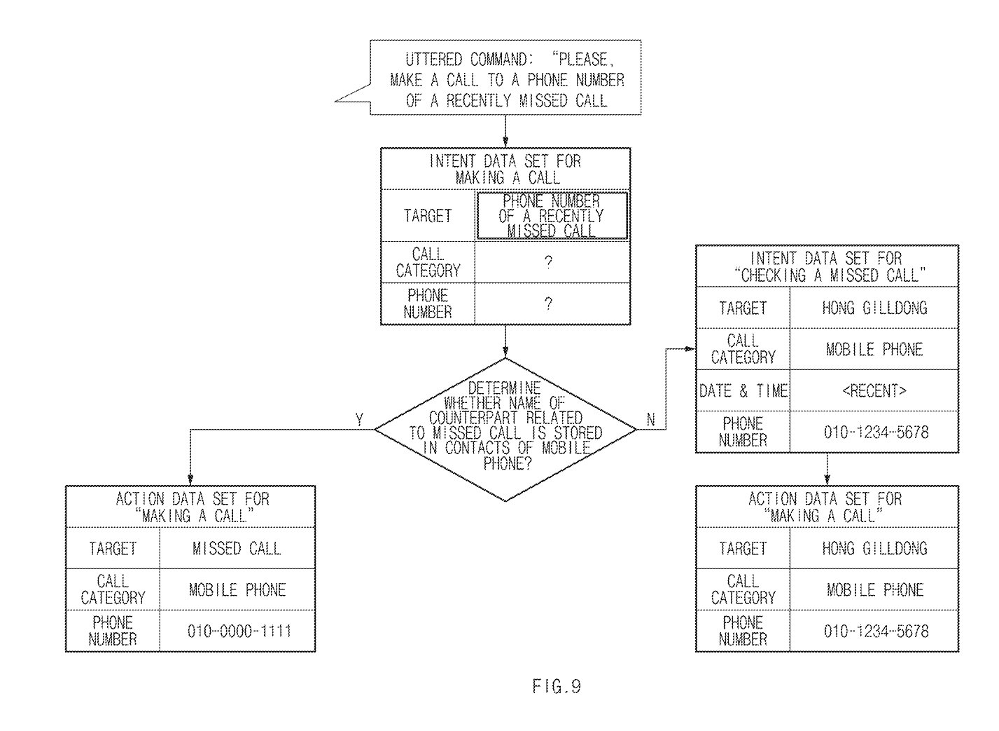

FIG. 9 is a schematic view illustrating the voice recognition method according to embodiments of the present disclosure e.

If the uttered command is “Please, make a call to a phone number of a recently missed call”, the controller 10 may determine the uttered command to have a single intent since a linker is absent from the uttered command. In addition, the controller 10 may analyze the intent of the utterer as being “making a call”. The controller 10 may extract an intent data set for “making a call”, which is shown below in Table 5.

TABLE 5
Intent Data Set For “Making a Call”

| Entity | Content |
|---|---|
| Target | Phone number of recently |
| | missed call |
| Call Category | ? |
| Phone Number | ? |

Since the target of “making a call” is a phone number of a recently missed call, the controller 10 determines whether the name of a counterpart related to the missed call is stored in contacts of a mobile phone. If the name of the counterpart is stored in the contents of the mobile phone, the controller creates the action data set as shown below in Table 6 and the output device 30 determines and outputs the feedback message. The controller 10 may determine the feedback message to be a message of “I will make a call to a phone number of a missed call”, and may output the feedback massage in the form of a voice or an image.

TABLE 6
Action Data Set For “Making a Call”

| Entity | Content |
|---|---|
| Target | Missed Call |
| Call Category | Mobile Phone |
| Phone Number | 010-0000-1111 |

Meanwhile, if the name of the counterpart related to the missed call is not stored in the contacts of the mobile phone, the controller 10 may extract a new intent data set based on content, which is linked to another intent, among contents of the first uttered command. For example, the controller 10 may additionally extract an intent data set for “checking a missed call”, which is shown below in Table 7.

TABLE 7
Intent Data Set For “Checking A Missed Call”.

| Entity | Content |
|---|---|
| Target | Hong, Gilldong |
| Call Category | Phone Number |
| Date And Time | Recently |
| Phone Number | 010-1234-5678 |

Accordingly, the controller 10 maps contents of the intent data set for “checking a missed call” in Table 7 to contents of the intent data set for “making a call” in Table 5. The controller 10 infers content of an entity which is not acquired from the intent data set for “making a call” in Table 5. In addition, the controller 10 may create an action data set using the inferred content as shown below in Table 8.

TABLE 8
Action data set for making call

| Entity | Content |
|---|---|
| target | Hong, GilDong |
| Call category | Phone number |
| Phone number | 010-1234-5678 |

In addition, the controller 10 may determine a feedback message from the action data set. According to embodiments of the present disclosure, the controller 10 may determine the feedback message to be a message of “I will make a call to Hong, Gil-Dong”. In addition, the output device 30 may output the feedback message in the form of a voice or an image.

FIG. 10 is another schematic view illustrating a voice recognition method according to embodiments of the present disclosure.

If the uttered command is “Set a destination to center AA, and send information on a destination to James in a text message”, the controller 10 may determine the uttered command to have multiple intents since a linker is included in the uttered command.

In addition, the controller 10 may divide the command into intent-based sentences of “set a destination to center AA” and “send information on the destination to James in a text message” and may analyze the intents of the utterer as setting a destination and sending a text message.

The controller 10 may extract intent data sets for “setting a destination” and “sending a text message” based on the intents of the utterer, which are shown below in Tables 9 and 10.

TABLE 9
Intent Data Set For “Setting A Destination”

| Entity | Content |
|---|---|
| Name Of Poi | AA Center |
| Region | Hwaseong, Gyeonggi-Do. |

TABLE 10
Intent Data Set For “Sending A Text Message”

| Entity | Content |
|---|---|
| Name | James |
| Message | Destination |

In the case that the intent data set for “sending a text message” is extracted, the controller 10 may commonly map information of other entities without limiting to the mapping between the information of an entity to the information of the common entity, as described above with reference to FIG. 4.

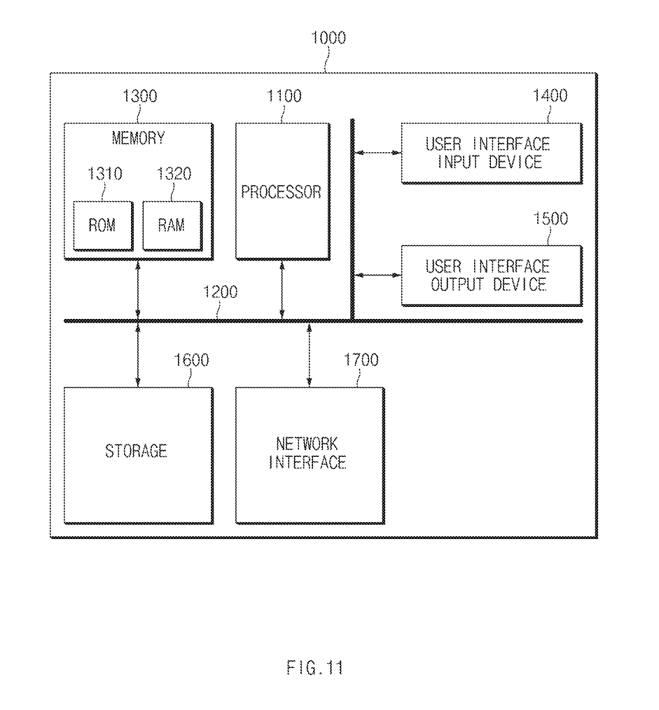

In other words, referring to Table 9 and 10 above, there is no common entity between the intent data set for “setting a destination” and the intent data set for “sending a text message”. However, the entity related to “message” in the intent data set for “sending a text message” may be mapped to entities related to “destination” in the intent data set for “setting a destination”. In addition, the controller 10 may infer the content of the “message” from the content of an entity related to “destination” and may create an action data set as shown in FIG. 11.

TABLE 11
Action Data Set For “Sending A Text Message”

| Entity | Content |
|---|---|
| Name | James |
| Message | AA center |

The controller 10 may determine a feedback message from the action data set created as shown above in Table 11.

According to an embodiment, the feedback message may be determined to be a message of “send ‘center AA’ to James”. In addition, the output device 30 may output the feedback message in the form of a voice or an image.

FIG. 11 is a block diagram illustrating a computing system to execute the method according to embodiments of the present disclosure.

As shown in FIG. 11, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

In the voice recognition system and the voice recognition method for analyzing a command having multiple intents according to the present disclosure, when the voice of the utterer is recognized inside a vehicle, the multiple intents of the utterer are detected by connecting meanings between the multiple intents. Accordingly, multiple contents may be automatically linked to each other to execute multiple commands.

Hereinabove, although the present disclosure has been described with reference to certain embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

What is claimed is:

1. A voice recognition system for analyzing an uttered command having multiple intents, the voice recognition system comprising:
a controller configured to receive the uttered command, extract a plurality of intent data sets from the uttered command, determine a second intent data set from a first intent data set among the extracted plurality of intent data sets, and generate a feedback message based on the second intent data set and the first intent data set;
a storage configured to store the uttered command and the extracted plurality of intent data sets; and
an output device configured to output the feedback message.

2. The voice recognition system of claim 1, wherein the controller is further configured to determine content of a first entity among a plurality of entities included in the first intent data set, and determine, from the content of the first entity, content of a second entity, which is the same as the first entity, among a plurality of entities included in the second intent data set.

3. The voice recognition system of claim 1, wherein the controller is further configured to detect whether a linker is present in the uttered command, and determine that the uttered command has multiple intents when the linker is detected in the uttered command.

4. The voice recognition system of claim 3, wherein the controller is further configured to divide the uttered command into a plurality of intent-based sentences, and determine the multiple intents based on the divided plurality of intent-based sentences.

5. The voice recognition system of claim 4, wherein the controller is further configured to extract the plurality of intent data sets based on the multiple intents determined from the plurality of intent-based sentences.

6. The voice recognition system of claim 4, wherein the controller is further configured to divide the uttered command into the plurality of intent-based sentences through morphological and parsing analyses.

7. The voice recognition system of claim 2, wherein the controller is further configured to associate the first intent data set with the second intent data set.

8. The voice recognition system of claim 1, wherein the controller is further configured to determine the second intent data set based on external content information when the second intent data set fails to be determined from the first intent data set.

9. The voice recognition system of claim 1, wherein the controller is further configured to detect a meaning of the uttered command through a text analysis.

10. The voice recognition system of claim 1, wherein, when a link is detected to be absent from the uttered command, the controller is further configured to extract an intent data set based on an intent of the utterer, and additionally extract a new intent data set based on a meaning of the uttered command.

11. The voice recognition system of claim 1, wherein the controller is further configured to extract a plurality of intent data sets including an intent data set for text sending when a portion of contents of the uttered command includes content for the text sending, and determine content of a specific entity included in the intent data set for the text sending from content of a specific entity included in an intent data set extracted based on contents of the uttered command except for the content for the text sending.

12. The voice recognition system of claim 1, wherein the controller is further configured to generate an action data set, which includes one or more results corresponding to the uttered command, based on the plurality of intent data sets.

13. The voice recognition system of claim 12, wherein the controller is further configured to generate the feedback message based on the action data set.

14. The voice recognition system of claim 1, wherein the output device is further configured to output the feedback message in a form of a voice or an image.

15. A voice recognition method for analyzing an uttered command having multiple intents, the voice recognition method comprising:
receiving the uttered command;
extracting a plurality of intent data sets from the command;
determining a second intent data set from a first intent data set among the extracted plurality of intent data sets;
generating a feedback message based on the first intent data set and the second intent data set; and
outputting the feedback message using an output device.

16. The voice recognition method of claim 15, wherein the extracting of the plurality of intent data sets includes:
determining whether the uttered command has multiple intents.

17. The voice recognition method of claim 16, wherein the determining of whether the uttered command has multiple intents includes:
detecting whether a linker is present in the uttered command; and
determining that the uttered command has multiple intents when the linker is detected in the uttered command.

18. The voice recognition method of claim 16, wherein the extracting of the plurality of intent data sets further includes:
dividing the uttered command into a plurality of intent-based sentences; and
determining the multiple intents based on the divided plurality of intent-based sentences.

19. The voice recognition method of claim 18, wherein the dividing of the uttered command includes:
dividing the uttered command into the plurality of intent-based sentences through morphological and parsing analyses.

20. The voice recognition method of claim 18, wherein the extracting of the plurality of intent data sets further includes:
extracting the plurality of intent data sets according to the multiple intents from the plurality of intent-based sentences.

21. The voice recognition method of claim 20, wherein the first intent data set and the second intent data set each includes multiple entities.

22. The voice recognition method of claim 21, further comprising:
determining whether the plurality of intent data sets are associated with each other after the extracting of the plurality of intent data sets.

23. The voice recognition method of claim 22, wherein the determining of whether the multiple intent data sets are associated with each other includes:
determining the first intent data set as associated with the second intent data set when a common entity is extracted from both of the first intent data set and the second intent data set.

24. The voice recognition method of claim 22, further comprising:
determining the second intent data set from the first intent data set after the determining of whether the plurality of intent data sets are associated with each other.

25. The voice recognition method of claim 24, wherein the determining of the second intent data set from the first intent data set includes:
determining, from content of a first entity which is included in the first intent data set, content of a second entity which is included in the second intent data set, the second entity being the same as the first entity.

26. The voice recognition method of claim 24, further comprising:
determining the second intent data set based on external content information when the second intent data set fails to be determined from the first intent data set.

27. The voice recognition method of claim 16, further comprising:
additionally extracting a new intent data set based on a meaning of the uttered command, after the extracting of the plurality of intent data sets, when a linker is detected to be absent from the uttered command.

28. The voice recognition method of claim 15, further comprising:
extracting a plurality of intent data sets including an intent data set for text sending when a portion of content of the uttered command includes content for the text sending; and
determining information of a specific entity included in the intent data set for the text sending from an intent data set extracted according to contents of the uttered command except for the content for the text sending.

29. The voice recognition method of claim 15, further comprising:
generating an action data set, which includes one or more results corresponding to the uttered command, after the determining of the second intent data set from the first intent data set.

30. The voice recognition method of claim 29, wherein the generating of the feedback message includes:
generating the feedback message based on the action data set.

31. The voice recognition method of claim 15, wherein the outputting of the feedback message includes:
outputting the feedback message in a form of a voice or an image.
